(19) United States
(12) Patent Application Publication
(10) Pub. No.: US 2010/0185543 A1
(43) Pub. Date: Jul. 22, 2010

(54) Due diligence and finance method and system to lend on master art using the master art as the only collateral or to purchase master art

(76) Inventors: Peter Saile, Zurich (CH); Marlene Saile, Miami Beach, FL (US)

Correspondence Address: ROBERT M. SCHWARTZ, P.A., P.O. BOX 221470, HOLLYWOOD, FL, 33022, US

(21) Appl. No.: 12/689,499

(22) Filed: Jan. 19, 2010

Related U.S. Application Data
(60) Provisional application No. 61/145,161, filed on Jan. 16, 2009.

(51) Int. Cl. G06Q 40/00; G06Q 90/00

(52) U.S. Cl. 705/38; 705/500

(57) ABSTRACT

A method and system of facilitating transactions involving master art includes: identifying at least one piece of art as master art; pre-qualifying said master art for full due diligence; executing said full due diligence; establishing the authenticity of said master art; establishing the value of said master art, said value applied as collateral to:
(i) facilitate the lending of money; or
(ii) facilitate the quick private sale of said master art, said lending of money or proceeds from said sale being provided to an applicant possessing said master art and accessing said method.

### INDEX TO RELATED APPLICATIONS

This application claims the benefit of U.S. Provisional Patent No. 61/145,161 filed Jan. 16, 2009, the disclosure of which is incorporated herein by reference in its entirety.

### BACKGROUND OF THE INVENTION

A) Field of the Invention

This invention relates to a due diligence and finance method and system to: (i) facilitate the lending of money taking only master art as collateral, the master art is the single and exclusive source of collateral; (ii) facilitate the quick private sale and purchase of master art.

B) Description of Master Art, Master Art Lending Practices by Banks, Master Art Sale and Purchase Practices by Auction Houses/Dealers, Pawnbrokers.

### Master Art

Master art as used herein and within the concept of the invention shall mean paintings from a distinguished painter of the period from the sixteenth to the twentieth century with an average value of $10 million or more.

Businesses and individuals collect master art of such value either as an investment or as an aesthetic hobby. Master art derives its value from numerous factors including peoples' tastes, demand, quality, condition and recent sales, both public and private. Auction houses, such as Sotheby's, Christie's and Bonhams & Butterfields, and private art dealers auction and sell billions of dollars worth of master art each year. In effect, the global art market is an industry turning over an estimated $25 billion or more a year in sales transactions.

### Master Art Lending Practices by Banks

Art lending practices by banks in general are inefficient to both the banks and the borrowers. Banks view art as illiquid because securitization of art-backed loans is very risky. At present banks are required to hold eight percent (8%) of their liabilities as capital. This means that banks need to be able to adequately estimate and monitor all risks associated with changes in master art prices. This is not easy to do with master art because master art derives its value from numerous factors, some of which are subjective, including peoples' tastes, demand, quality, condition and recent sales, both public and private. Additionally, from an objective point of view there is a lack of an industry acceptable valuation index or indices. Furthermore, there major price differences in master art from artist to artist and different art movements and periods. This apparent difficulty in being able to estimate and monitor the risks associated with art price changes to a certain degree means that banks are unwilling to hold the master art's value to offset the art price risk on their balance sheets and they want to sell the debt. However this debt is difficult to sell and they must hold it. As a result banks charge interest rates as high as 18% to spread the risk, add other assets whose values can be estimated and monitored as collateral, and ask for personal guarantees as consideration for holding the default and art price risks. Banks in practice never lend solely taking the master art as collateral. A further consequence of the greater risk inherent in art prices is that the price at which banks value the art as collateral is likely to be significantly lower than its market value. Furthermore, banks do not usually have the necessary infrastructure of trained experts who can undertake the full due diligence process of establishing the authenticity and value of a piece of master art. Finally, if a bank does indeed process a loan transaction for which the master art is part of an entire collection of assets/personal guarantee, the transaction will take anywhere from nine months to a year, or potentially longer. Due to the above conditions a sub-optimal amount of lending occurs in the market for asset backed loans, when art is used as collateral.

Borrowers are usually wealthy individuals and major corporations who often are asset rich but are cash poor. With their capital tied up in assets they tend to want access to master art backed loans. However, as the banks do not have a quick and efficient system for lending on master art, owners of master art do not have easy access to such loans. In essence access to easy loans on master art does not exist.

### Master Art Sale and Purchase Practices by Auction Houses/Dealers

Even though auction houses and dealers auction and sell billions of dollars worth of master art each year, these avenues for master art sale and purchase are also inefficient to the seller if a seller is in a hurry to liquidate the piece of master art, as these auction houses and dealers are very slow and costly in processing a master art sales transaction. The major outlets for selling master art are the auction houses Sotheby's, Christie's and Bonhams & Butterfields. If a seller wants to sell through a major auction house, they will charge from fifteen to thirty percent (15-30%) in total commissions and other miscellaneous “fees” to get the art item packed, shipped, insured, and promoted. Furthermore, it's often a rather lengthy process as the auction houses only have sales 2-4 times a year. Furthermore, there is no guarantee the item will sell even though the seller is still responsible for the substantial other “fees.” Dealers operate in a similar fashion charging commissions from fifteen to thirty percent (15-30%). Usually a dealer will take up to a year before it can close a sale. Therefore, the sales market for master art is also inefficient to a seller that wants a quick private sale.

### Pawnshops

Pawnshops begin their process when an individual brings an item into their pawnshop. The pawnbroker then assesses it for its condition and saleability, as well as the amount the individual may need for it. If the pawnbroker is interested in the item, he offers the customer an amount for it. The customer can either sell the item outright if as in most cases the pawnbroker is also a licensed second hand sealer, or offer the item as collateral on a loan. If an item is pawned for a loan, within a certain contractual period of time the pawner may purchase it back for the amount of the loan plus the agreed-upon amount for interest. If the loan is not paid (or extended, if applicable) within the time period, the pawned item will be offered for sale by the pawnbroker/second hand dealer. Common items pawned by customers include inexpensive and unknown art, jewelry, electronics (this includes hardware such as televisions and computers and software such as video games, as well as movies), musical instruments, firearms, and tools (both hand tools and power tools). Gold is a very popular item, which is almost always purchased; even if the source (such as a piece of broken jewelry) has little value, the gold can still be sold in bulk to a bullion dealer or smelter for the value of the gold content.

However, although pawnbrokers will allow a person to obtain a short-term loan in exchange for an item of some value including art, it is also an inefficient system as to the owner of a piece of master art as the owner will not get the amount of the loan desired. Pawnbrokers have a limited amount of money they are willing to lend, usually up to $5,000. Pawnbrokers do not typically lend on master art, which values' are in the millions. Furthermore, pawnbrokers are not specially trained to do full due diligence to evaluate the artist, the market, the valuation, the history of ownership, the insurance, the authenticity, the condition, and search results from the Art Loss Register with respect to Jewish claims as to stolen art during WWII. Pawnbrokers operate out of a storefront where items are: brought in by the borrower, appraised, stored, and later resold. Pawnbrokers usually do not employ adequate security measures for protecting master art of high value, and do not have specialty master art storage, transportation, and packing. Pawnbrokers are not museum-trained professionals, artists, and crafts people that provide a wide range of art handling expertise to museums, galleries, auction houses and private collectors.

It is clear that it is in demand and desirable to have a due diligence and finance method and system that allows wealthy individuals and major corporations to: (i) access loans in exchange for only the master art as collateral, or (ii) sell master art quickly and privately. It is also clear that it is in demand and desirable to have a due diligence and finance method and system that facilitates such exchanges.

Through the introduction of the present invention the demand will be met, as the lender or seller is able to: (i) quickly supply a loan; or (ii) quickly purchase the master art piece. These transactions will take from sixty (60) to one hundred and eighty (180) days depending on the simplicity or complexity attendant to each transaction with respect to the master art and borrower/seller involved. Lender/buyer is willing to take the risk in valuation fluctuations that banks are not able to do. Lender/buyer is able to move quickly as banks, auction houses and dealers are not. Lender/buyer is able to lend on master art with an average of $10 million or more as the only collateral that banks and pawnbrokers are not able to do.

Furthermore, in addition to meeting the current demand, the present invention will:
Provide credit solutions to enable clients to manage the ups and downs of the economy;
Empower clients with additional buying power and liquidity when most needed by rapidly converting an illiquid asset into working capital;
Empower clients with additional liquidity without having to put up other assets as security;
Empower clients to keep ownership of their master art;
Empower clients to retain the benefit of any appreciation in the value of their master art while still enjoying the flexibility that capital leverage provides.

Lastly, as a default of the current invention, borrowers/sellers whose works pre-qualified for full due diligence and which were subsequently found to be fakes, copies or works from a lesser known artist, will be fully informed of the status of their art. Lender/buyer is willing to take the risk that this may be result even if the master art showed great promise of being a genuine piece of master art from a known master.

The due diligence and finance method and system of quickly qualifying master art for a loan of money or for purchase allows borrowers or sellers to submit an electronic application through lender/buyer's website from any location to find out if the particular master art piece pre-qualifies for full due diligence to ultimately determine if the master art piece will qualify for a loan or for a purchase. The borrower/seller specifies personal and master art information on the lender/buyer's website and then clicks and submits the information. The lender/buyer receives the information via its computer communications network and server. Lender/buyer reviews the information submitted and a viewing of the master art is scheduled. Thereafter, the master art is viewed, and the information submitted by borrower/seller on the master art is analyzed. Lender/buyer sends a notice stating that the application was denied or sends notice with a letter of intent that the master art pre-qualified for full due diligence. The letter of intent is executed for full due diligence to take place on the master art. Thereafter, full due diligence is conducted on the Master Art.

Once full due diligence has taken place and the master art has been approved as adequate collateral, a loan amount and the terms are offered. A promissory note and security agreement are executed. The borrower transfers the master art to the lender as collateral and the lender issues a letter of credit that becomes payable on the date the master art has been stored. Lender perfects its security interest by taking possession of the master art as the only collateral. Once the term of the loan is soon to expire, Lender sends notice that payment is due. If borrower pays, lender ships the collateral back to lender. If borrower defaults under the promissory note and security agreement, the lender has the option to (1) sell the master art covered by the security interest via a public or private sale; or (2) retain the master art covered by the promissory note and security agreement via strict foreclosure procedures if the borrower/lender agrees.

In the alternative, if it is a seller who wants to sell a piece of master, once full due diligence has taken place and the master art has been approved for purchase, a purchase amount and the terms are offered. A purchase agreement is executed. The seller transfers the master art to the lender and the lender issues a letter(s) of credit that becomes payable on the date the master art has been stored.

A system and method to: (i) facilitate the lending of money taking only master art as collateral; and (ii) facilitate the quick private sale and purchase of master art.

A due diligence and finance method and system to: (i) facilitate the lending of money taking only master art as collateral; (ii) facilitate the quick private sale and purchase of master art. The due diligence and finance method and system of quickly qualifying master art for a loan of money or for purchase allows borrowers or sellers to submit an electronic application through lender/buyer's website from any location to find out if the particular master art piece pre-qualifies for full due diligence to ultimately determine if the master art piece will qualify for a loan or for a purchase. The borrower/seller specifies personal and master art information on the lender/buyer's website and then clicks and submits the information. The lender/buyer receives the information via its computer communications network and server. Lender/buyer reviews the information submitted and a viewing of the master art is scheduled. Thereafter, the master art is viewed, and the information submitted by borrower/seller on the master art is analyzed. Lender/buyer sends a notice stating that the application was denied or sends notice with a letter of intent that the master art pre-qualified for full due diligence. The letter of intent is executed for full due diligence to take place on the master art. Thereafter full due diligence takes place.

Once full due diligence has taken place and the master art has been approved as adequate collateral, a loan amount and the terms are offered. A promissory note and security agreement are executed. The borrower transfers the master art to the lender as collateral and the lender issues a letter of credit that becomes payable on the date the master art has been stored. Lender perfects its security interest by taking possession of the master art as the only collateral. Once the term of the loan is soon to expire, Lender sends notice that payment is due. If borrower pays, lender ships the collateral back to lender. If borrower defaults under the promissory note and security agreement, the lender has the option to (1) sell the master art covered by the security interest via a public or private sale; or (2) retain the master art covered by the promissory note and security agreement via strict foreclosure procedures if the borrower/lender agrees.

In the alternative, if it is a seller who wants to sell a piece of master, once full due diligence has taken place and the master art has been approved for purchase, a purchase amount and the terms are offered. A purchase agreement is executed. The seller transfers the master art to the lender and the lender issues a letter(s) of credit that becomes payable on the date the master art has been stored.

### BRIEF DESCRIPTION OF THE FIGURES

FIG. 1 is a block diagram illustrating all the interacting, interrelated, and interdependent modules forming the due diligence and finance method and system of the present invention.

FIG. 2a is a flowchart illustrating the steps of the present invention for a master art loan.

FIG. 2b is flowchart illustrating the steps of the present invention for a master art purchase.

FIG. 3 is a flowchart illustrating the steps undertaken to determine if a piece of master art pre-qualifies for full due diligence;

FIG. 4 is a flowchart illustrating the steps in due diligence of master art;

FIG. 5a is a flowchart illustrating the steps undertaken to process a master art promissory note and security agreement.

FIG. 5b is a flowchart illustrating the steps undertaken to process a master art purchase;

FIG. 6 is a flowchart illustrating the steps undertaken to process a master art loan pay off;

FIG. 7 is a flowchart illustrating the steps undertaken to process a master art loan default;

FIG. 8 is a flowchart illustrating the operation of inventory management of the master art.

### DETAILED DESCRIPTION OF THE DRAWINGS

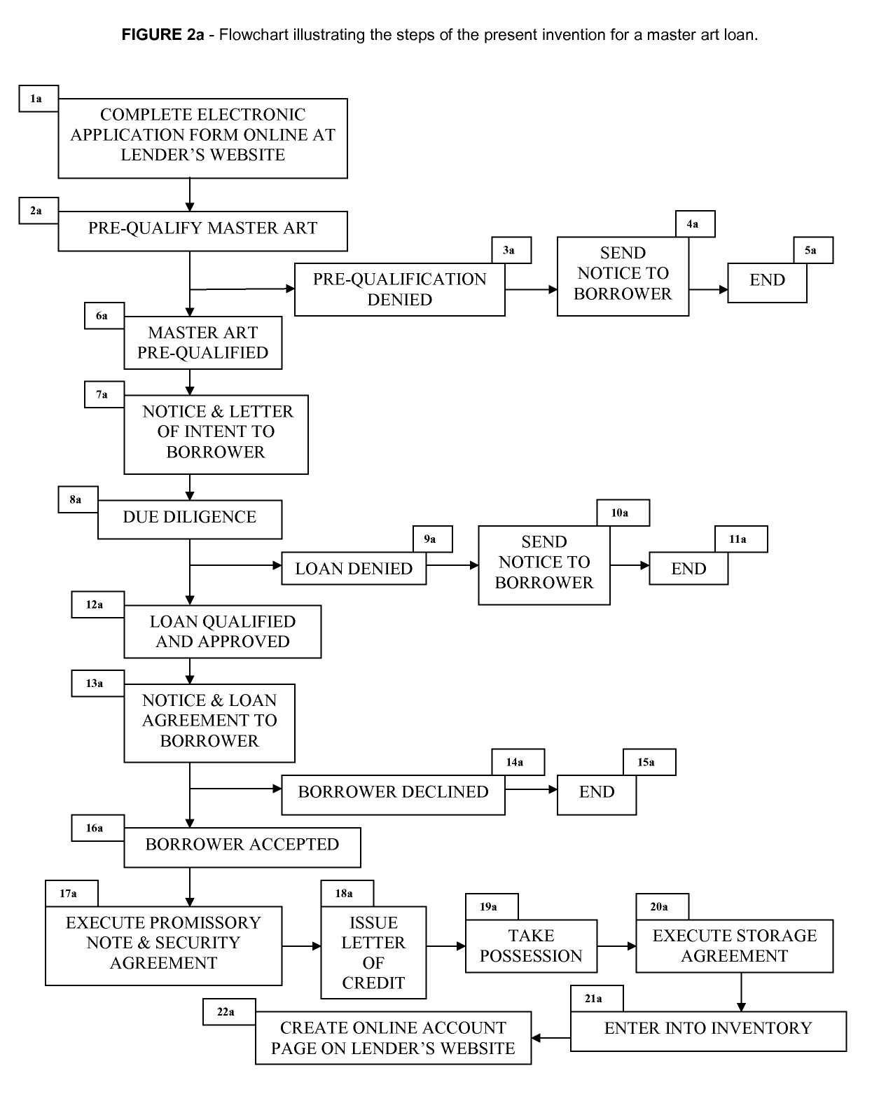

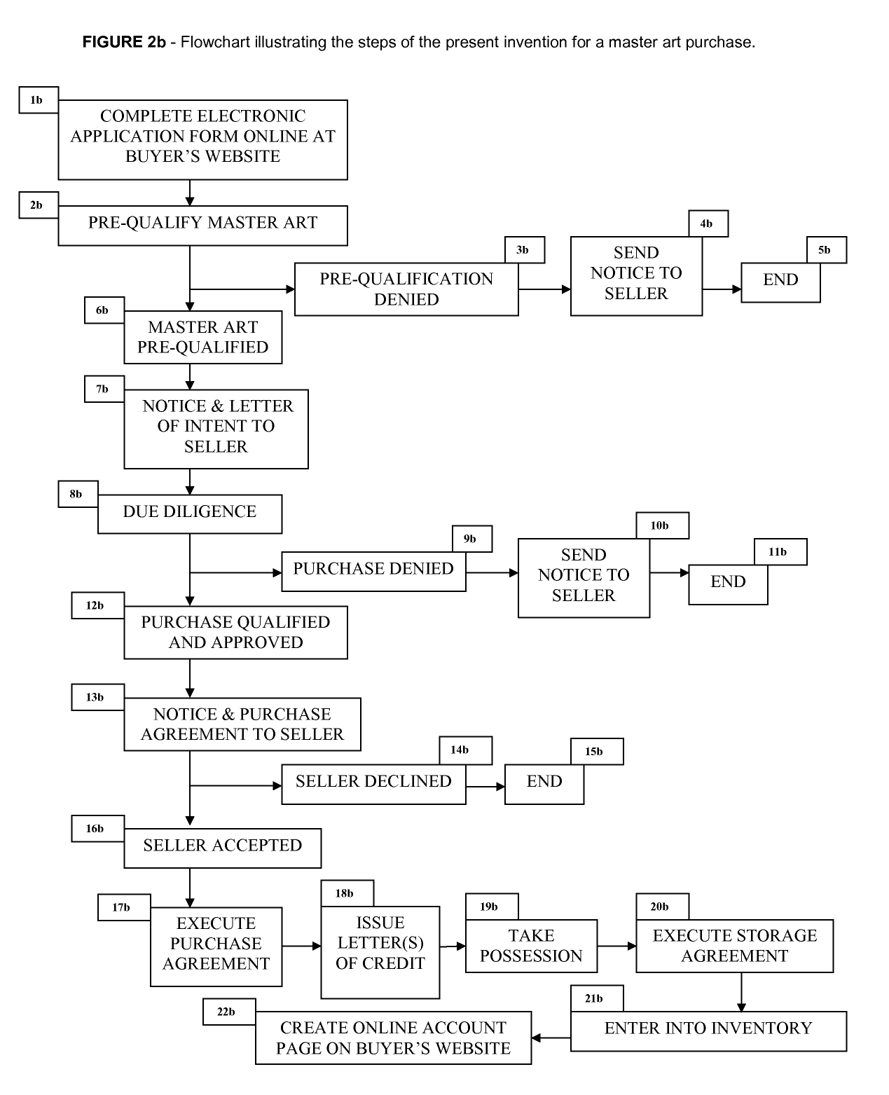

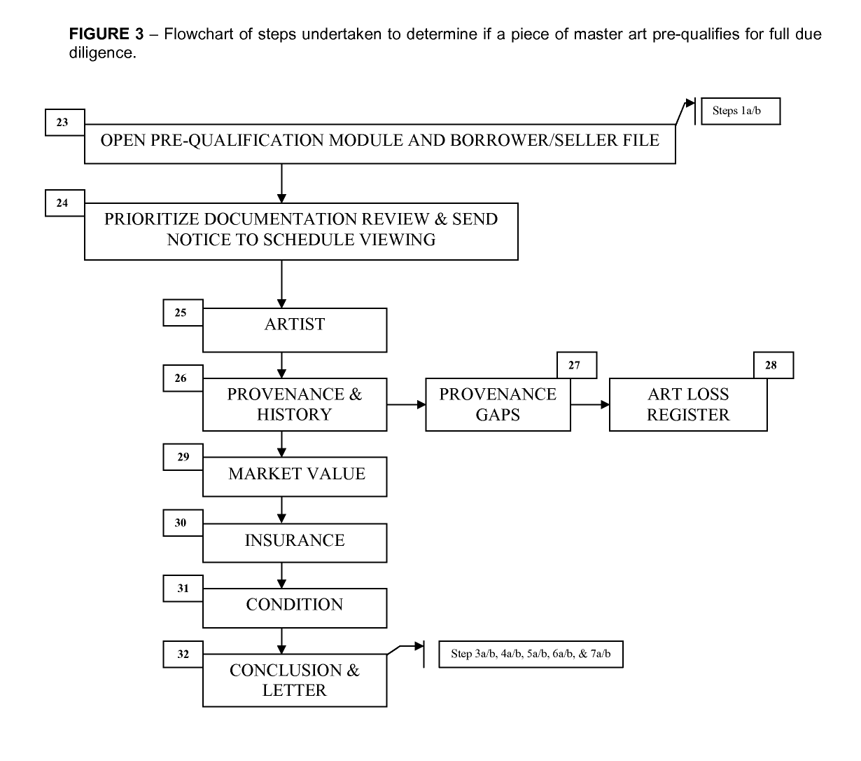

The detailed description given herein and the accompanying drawings of the various embodiments of the invention are given for purposes of explanation of the present invention very clearly. However, as a caveat they should not be taken to limit the invention to the specific descriptions and embodiments, but are for explanation and understanding purposes only as it will be apparent to an art expert that all these specific details may not be required to practice the present invention. The same parts are denoted by the same reference numerals. Where applicable, such as in FIGS. 2a, 2b, 5a and 5b, 6, and 7, a separate drawing has been made when the transaction involves either a loan or a purchase. In other Figs. the respective parties are referred to as “borrower/seller” or “lender/buyer” or the transaction is referred to as “loan/purchase” as the case may be as the modules of the present invention apply in a similar fashion in these instances to either a loan or a purchase and are collective thereto as in FIGS. 3, 4 and 8. It is understood that lender/buyer are the same entity or separate entities under one or more holding companies.

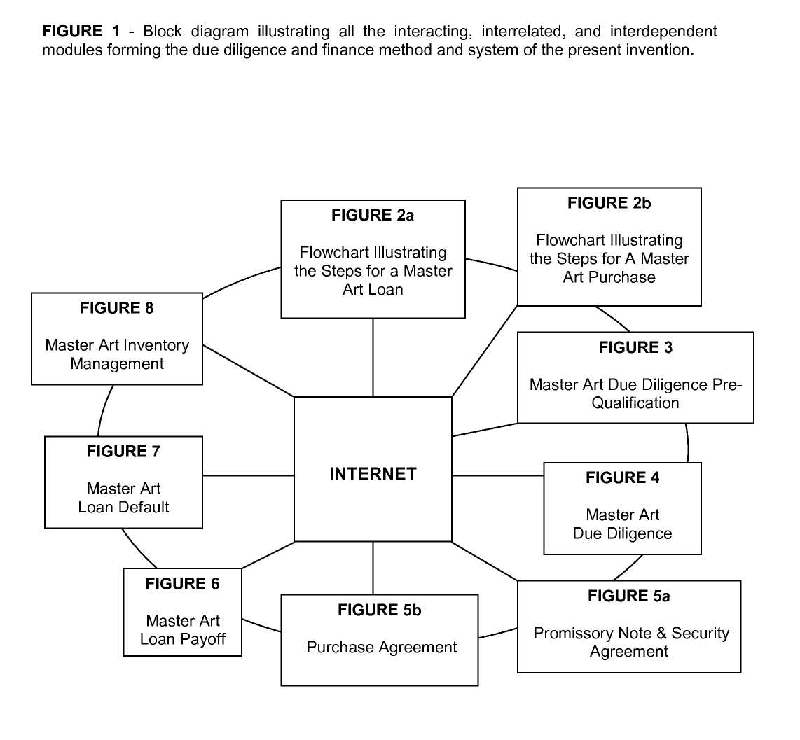

An overview of the system used to accomplish the present invention is illustrated in FIG. 1.

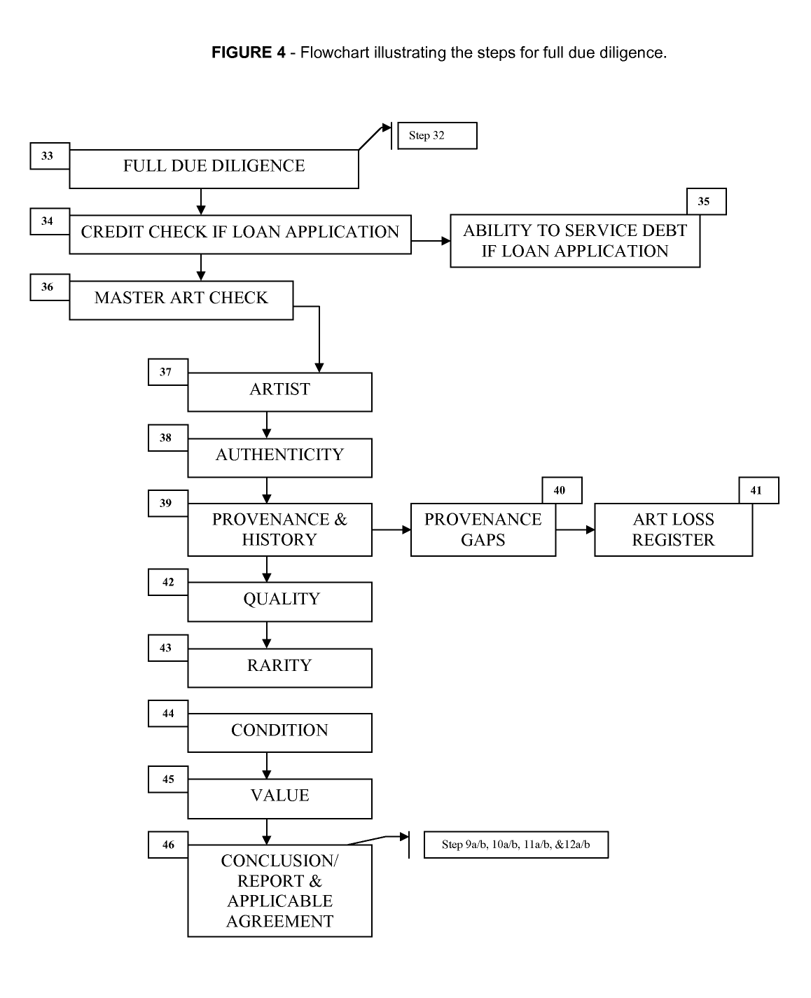

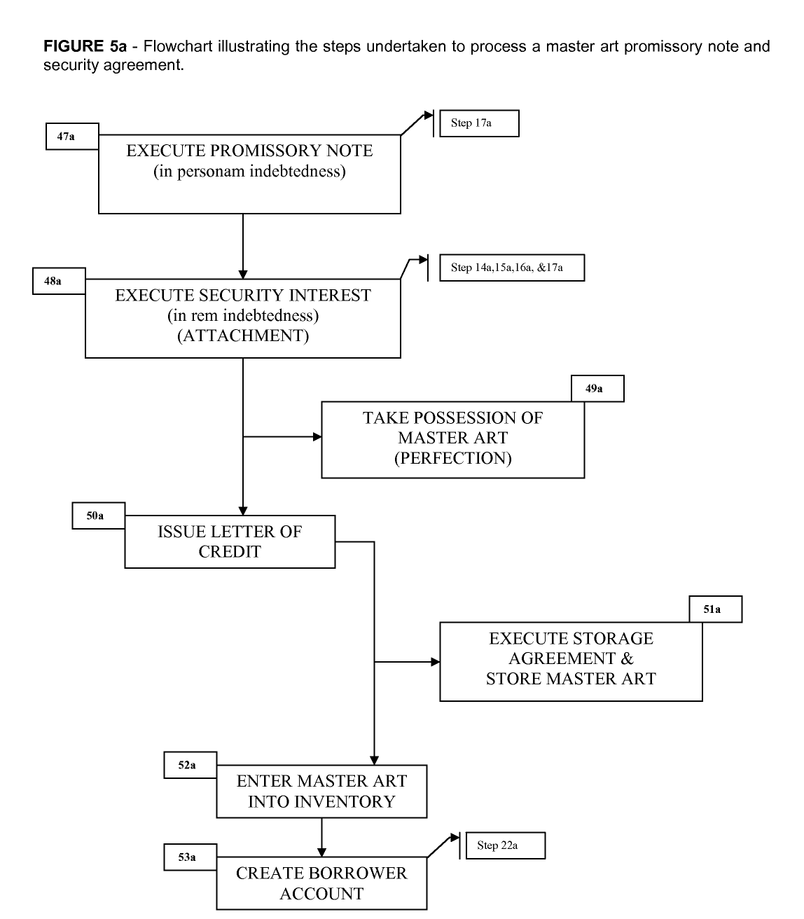

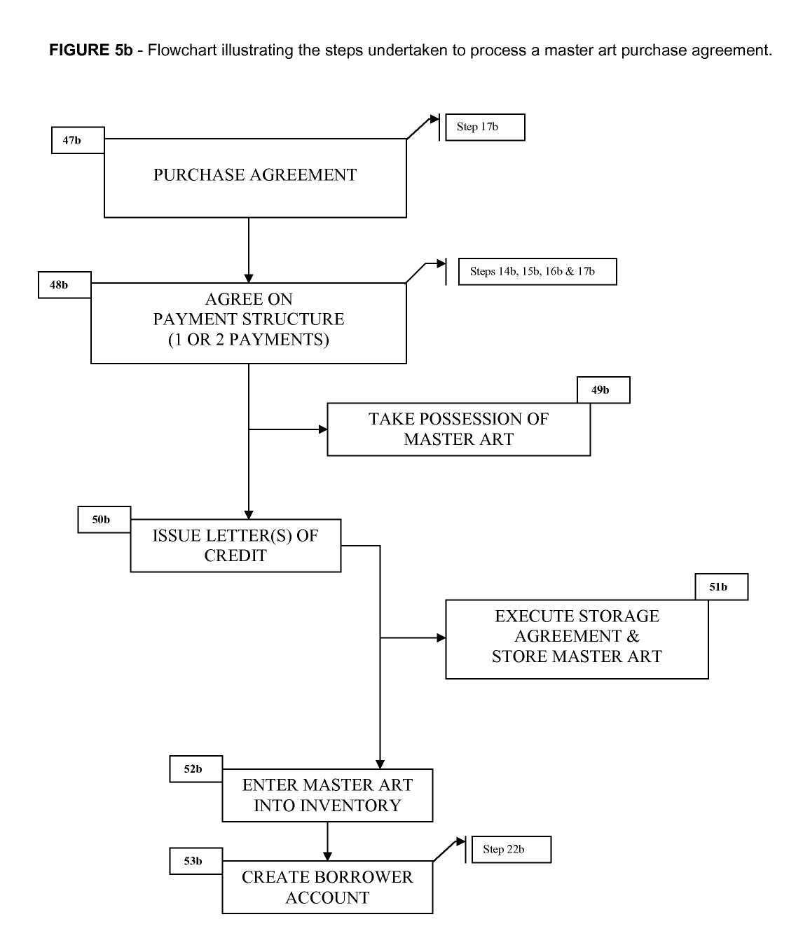

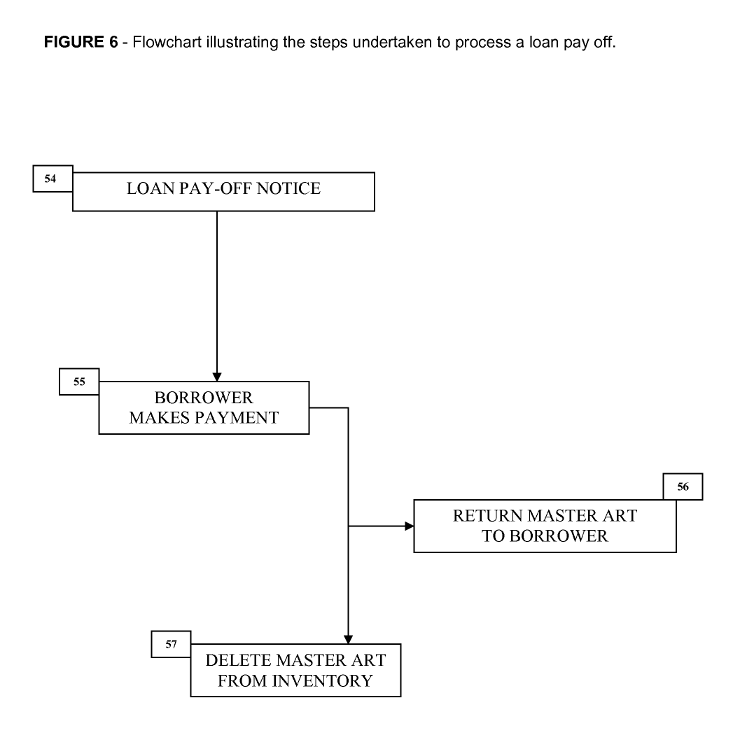

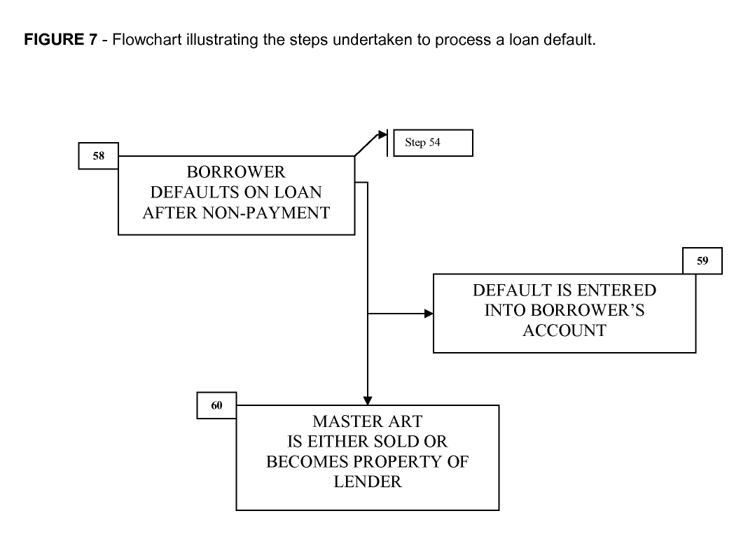

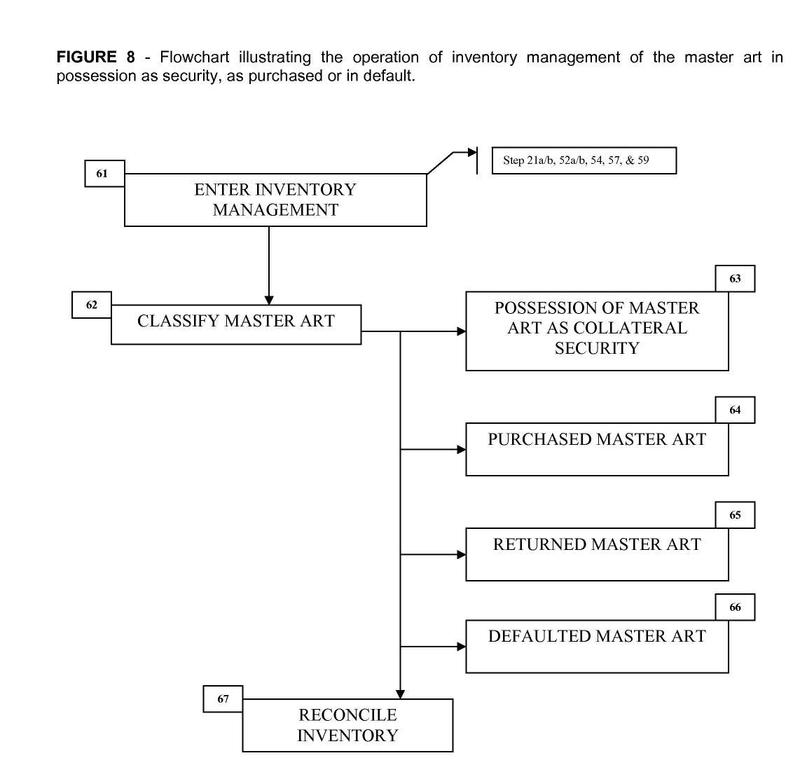

FIG. 1 is a block diagram illustrating all the interacting, interrelated, and interdependent modules forming the due diligence and finance method and system used to accomplish the present invention. An embodiment of the present invention contains a variety of different modules each connected to each other via the Internet. FIG. 2a is a flowchart illustrating the steps for a master art loan. DRAWING 2b is a flowchart illustrating the steps for a master art purchase. The modules include a module FIG. 3 configured to handle the pre-qualification of master art; a module FIG. 4 configured to handle the process of full due diligence; a module FIG. 5a configured to process the promissory note and security agreement; a module FIG. 5b configured to process the purchase of master art; a module FIG. 6 configured to handle the loan payoff process, a module FIG. 7 configured to handle the loan default, and a module FIG. 8 configured to handle master art inventory management. The modules may operate on any type of computer system that is currently known or may be developed in the future. The computer system typically includes an input device such as a keyboard, a display device such as a monitor, a processor, main memory, such as a random access memory (RAM) or other memory device, a bus, a non-volatile memory such as a hard disk and a processor for executing instructions. Such a computer system may be connected to the Internet in a variety of different ways, including via a cable modem, a DSL connection, a dial-up connection, a T1 line, or any other wired or wireless connection. Users in separate and distant locations through the INTERNET may access the modules in FIG. 1. They need not be located in near proximity to each other as the various modules are stored on a proprietary web server and accessed via an Internet browser or through a network that is capable of communicating digital information from one place to another, whether wired or wireless. Furthermore, various modules may be located within a single computer system or they may be located in distinct, distant places. The modules in FIG. 1 have several forms and may be implemented in a variety of programmable ways. A module may be a distinct set of hardware, firmware, and software dedicated to perform a certain task whether proprietary or licensed. Alternatively, a module may be a section of computer code within a larger set of code. A module has web pages that allow data entry, data viewing, and data transmission. The modules may execute on any type of computer system currently known or developed in the future.

In the foregoing specification, the invention has been described with reference to specific modules as embodiments thereof. However, the specifications in the figures are to be regarded as flexible illustrations intended in a generic and descriptive sense and not for the purpose of limitation, as modifications and changes may be made to them without departing from the scope of the invention.

FIG. 2a is a flowchart illustrating the steps of the present invention for a master art loan.

At step 1a, borrower completes the electronic application form online at lender's website and submits the application to the lender to begin the loan approval process. The borrower enters personal information such as name, address, e-mail address, and telephone including information giving a description as to the master art to be used as the collateral. The information as to the master art may include all the information the borrower has, including but not limited to, photographs, an authenticity and provenance report, or what is called a “certificate of authenticity”, and a condition report. The system of the present invention creates a file for the application under the name of the applicant, the name of the artist, and the title of the master art. Further, classifications of the master art in question may be utilized such as the medium used, school, art movement, period of creation and the like.

At step 2a, before any decision to proceed with the full range of research and examination under an extensive full due diligence procedure required to establish authentication and value, it is necessary to perform a preliminary examination of the documentation submitted and the master art in order to pre-qualify it. There is no substitute for the actual object! Therefore, lender schedules a viewing of the master art to do a cursory technical pre-assessment to determine if the master art pre-qualifies for full due diligence. After examination of the master art and accompanying documentation a written letter of the advisability to proceed or not proceed will be generated.

At step 3a, 4a and 5a the system of the present invention creates and sends a letter notifying the borrower that the master art did not pre-qualify for further full due diligence and that the application has been denied. The system classifies the application as denied and files the file created in Step 1a in a file labeled “denied loan pre-qualification applications” under the name of the applicant, the name of the artist and the title of the master art and the process ends.

At step 3a, a piece of master art may be denied for further full due diligence because it failed to meet the preliminary criteria established by the lender on the basis of the submitted documentation and the viewing of the master art. The criteria includes, but is not limited to, that upon viewing the piece of master art, it did not seem to be a work of art of the artist in question either because of the style, the technique, the colors or the signature; or the provenance report has too many gaps in the chain of ownership to give an estimation that the piece of master art is from the artist; or the conservation report shows that the piece of master art has too much costly and/or irremediable damage; or search results from the Art Loss Register shows the piece of master art may be subject to an existing claim. Pre-qualification may also be declined if there is not enough information regarding the piece of master art. There may also be other reasons for which pre-qualification may be declined.

At step 6a and 7a the system of the present invention creates a notification with a letter of intent notifying the borrower that the master art pre-qualified for full due diligence giving instructions to execute the attached letter of intent to be sent back for further execution by lender. Borrower must execute the letter of intent that includes acceptance of the “Terms and Conditions for Due Diligence”.

At step 6a, a piece of master art may be qualified for further full due diligence because it met the preliminary criteria established by the buyer on the basis of the submitted documentation and the viewing of the master art. The criteria includes, but is not limited to, that upon viewing the piece of master art, it seems to be a work of art of the artist in question either because of the style, the technique, the colors or the signature; or the provenance report has no gaps in the chain of ownership to give an estimation that the piece of master art is from the artist; or the conservation report shows that the piece of master art has affordable and/or remediable damage; or search results from the Art Loss Register shows the piece of master art has no claim. There may also be other reasons for which master art is pre-qualified.

At step 8a the lender proceeds to full due diligence on both the borrower and the master art. Lender will do a basic credit check credit and ability to service the debt on the borrower. However, as a result of the value of the master art, the credit worthiness and ability to service the debt is not paramount in determining whether a loan is approved.

What is paramount is the full due diligence on the master art in order to establish its authenticity and value in order to determine whether it will qualify for a loan. Therefore, the process begins with the master and attributing the piece of art as genuine and from that particular master's hand or authenticity. Once authenticity has been established, the process is dynamic and it is determined by the circumstances unique to each piece of master art. The process continues with provenance, quality, rarity, conservation, and finally to value.

At step 9a, 10a, 11a, the system of the present invention creates and sends a letter notifying the borrower that the master art did not qualify for a loan and that the application has been denied. The system classifies the application as denied and files the file created in Step 1a in a file labeled “denied loan applications” under the name of the applicant, the name of the artist and the title of the master art. The process ends. A piece of master art may be denied for a loan because it failed to be authenticated as the original work of the artist because of a variety of reasons or because the master art's value is not enough to be collateral for obtaining a loan. There may be various other reasons that a loan application may be denied.

At step 12a, 13a the system of the present invention creates a notification with a promissory note and security agreement notifying the borrower that the master art qualified and was approved for a loan, explaining the loan offer and giving instructions to execute the attached promissory note and security agreement to be sent back for further execution by lender.

At step 14a, 15a the system of the present invention makes a note that borrower has declined the loan offer. The system classifies the loan offer as declined and files the file in a file labeled “declined loan offers” under the name of the applicant, the name of the artist and the title of the master art. The process ends.

At step 16a, the system of the present invention makes a note that borrower has accepted the loan offer. The system classifies the loan offer as accepted and files the file in a file labeled “accepted loans” under the name of the applicant, the name of the artist and the title of the master art.

At step 17a, the promissory note and security agreement is executed which is transmitted to the lender in any one of a variety of different methods, including via fax, e-mail, first-class mail, or via overnight courier.

At step 18a, lender issues a letter of credit to the borrower in the amount of the loan that becomes payable on the date lender takes possession of the master art.

At step 19a, lender takes possession of the master art as the only collateral.

At step 20a, lender concludes a storage agreement in its name.

At step 21a, the collateral master art is entered into inventory as collateral security and its exact location is recorded on the file.

At step 22a, the system of the present invention creates a private online account page on lender's website where borrower can sign in using a dedicated user identification and password, to see the time remaining on the loan and the status of his/her account. The lender stores the collateral master art until the borrower either repays the loan amount or defaults on the loan.

FIG. 2b is a flowchart illustrating the steps of the present invention for a master art purchase.

At step 1b, in this case the seller completes the electronic application form online at buyer's website and submits the application to the buyer for purchase approval. The seller enters personal information such as name, address, e-mail address, telephone including information giving a description as to the master art to be sold. The information as to the master art may include all the information the seller has, including but not limited to, photographs, an authenticity and provenance report, or what is called a “certificate of authenticity”, and a condition report. The system of the present invention creates a file for the application under the name of the applicant, the name of the artist and the title of the master art. Further, classifications of the master art in question may be utilized such as the type of medium used, school, art movement, period of creation and the like.

At step 2b, before any decision to proceed with the full range of research and examination under an extensive full due diligence procedure required to establish authentication and value, it is necessary to perform a preliminary examination of the documentation submitted and the master art in order to pre-qualify it. There is no substitute for the actual object! Therefore, buyer schedules a viewing of the master art to do a cursory technical pre-assessment to determine if the master art pre-qualifies for full due diligence. After examination of the master art and accompanying documentation a written letter of the advisability to proceed or not proceed will be generated.

At step 3b, 4b and 5b the system of the present invention creates and sends a letter notifying the seller that the master art did not pre-qualify for further full due diligence and that the application has been denied. The system classifies the application as denied and files the file created in Step 1b in a file labeled—“denied purchase pre-qualification applications” under the name of the applicant, the name of the artist and the title of the master art and the process ends.

At step 3b, a piece of master art may be denied for further full due diligence because it failed to meet the preliminary criteria established by the buyer on the basis of the submitted documentation and the viewing of the master art. The criteria includes, but is not limited to, that upon viewing the piece of master art, it did not seem to be a work of art of the artist in question either because of the style, the technique, the colors or the signature; or the provenance report has too many gaps in the chain of ownership to give an estimation that the piece of master art is from the artist; or the conservation report shows that the piece of master art has too costly and/or irremediable damage; or search results from the Art Loss Register shows the piece of master art may be subject to an existing claim. Pre-qualification may also be declined if there is not enough information regarding the piece of master art. There may also be other reasons for which pre-qualification may be declined.

At step 6b and 7b the system of the present invention creates a notification with a letter of intent notifying the seller that the master art pre-qualified for full due diligence giving instructions to execute the attached letter of intent to be sent back for further execution by buyer. Seller must execute the letter of intent that includes acceptance of the “Terms and Conditions for Due Diligence”.

At step 6b, a piece of master art may be qualified for further full due diligence because it met the preliminary criteria established by the buyer on the basis of the submitted documentation and the viewing of the master art. The criteria includes, but is not limited to, that upon viewing the piece of master art, it seems to be a work of art of the artist in question either because of the style, the technique, the colors or the signature; or the provenance report has no gaps in the chain of ownership to give an estimation that the piece of master art is from the artist; or the conservation report shows that the piece of master art has affordable and/or remediable damage; or search results from the Art Loss Register shows the piece of master art has no claim. There may also be other reasons for which master art is pre-qualified.

At step 8b the buyer proceeds to full due diligence on only the master art to establish its authenticity and value in order to determine whether it will qualify for purchase. Therefore, the process begins with the master and attributing the piece of art as genuine and from that particular master's hand or authenticity. Once authenticity has been established, the process is dynamic and it is determined by the circumstances unique to each piece of master art. The process continues with provenance, quality, rarity, conservation, and finally to value.

At step 9b, 10b, 11b, the system of the present invention creates and sends a letter notifying the seller that the master art did not qualify for purchase and that the application has been denied. The system classifies the application as denied and files the file created in Step 1a in a file labeled “denied purchase applications” under the name of the applicant, the name of the artist and the title of the master art. The process ends.

A piece of master art may be denied for a purchase because it failed to be authenticated as the original work of the artist because of a variety of factors and/or because the master art's value is not enough to be collateral for obtaining a loan. There may be various other reasons that a purchase application may be denied.

At step 12b, 13b the system of the present invention creates a notification with a purchase agreement notifying the seller that the master art qualified and was approved for purchase, explaining the purchase offer and giving instructions to execute the attached purchase agreement to be sent back for further execution by buyer.

A piece of master art may be approved for a purchase because it was authenticated as the original work of the artist because of a variety of factors and/or because the master art's value is enough to be collateral for obtaining a loan. There may be various other reasons that a purchase application may be approved.

At step 14b, 15b, the system of the present invention makes a note that seller has declined the purchase offer. The system classifies the purchase offer as declined and files the file in a file labeled “declined purchase offers” under the name of the applicant, the name of the artist and the title of the master art. The process ends.

At step 16b, the system of the present invention makes a note that seller has accepted the purchase offer. The parties can agree to a full payment of the purchase price or two (2) payments. For a number of economic, business and tax reasons, a seller may wish to receive the purchase price in two (2) payments. The parties agree that even though payment is structured in two (2) payments, the seller will take possession of the master art and seller will issue two (2) letters of credit. The time span between the first and second payment cannot be longer than four (4) months. The first letter of credit is payable on the date buyer takes possession. The second letter of credit is payable on the date agreed to by the parties up to four (4) months from the date of the first payment. The system classifies the purchase as accepted and files the file in a file labeled “accepted purchase offers” under the name of the applicant, the name of the artist and the title of the master art.

At step 17b, the purchase agreement is executed which is transmitted to the buyer in any one of a variety of different methods, including via Fax, e-mail, first-class mail, or via overnight courier.

At step 18b, buyer issues one or two letters of credit to the seller depending on what the parties agree.

At step 19b, lender takes possession of master art.

At step 20b lender concludes a storage agreement in its name.

At step 21b, the master art is entered into inventory as purchased and its exact location is recorded on the file.

At step 22b, the system of the present invention creates a private online account page on buyer's website where buyer can sign in using a dedicated user identification and password, to see the status of his/her account in the event it has chosen a two (2) payment structure as shown in steps 48b-50b.

FIG. 3 is a flowchart illustrating the steps undertaken to determine if a piece of master art pre-qualifies for full due diligence. As stated before in Steps 2a and 2b, pre-qualification involves only looking at the existing documentation the borrower/seller may have and from it make a determination of whether it weighs enough to proceed to a full due diligence investigation.

At step 23 the system of the present invention opens the module for pre-qualification and the lender/buyer opens the file the system created at step 1a or 1b depending on whether the application is ultimately for a loan or a purchase.

At step 24 the lender/buyer will prioritize the preliminary review of the documentation the borrower/seller has submitted on the master art. The system of the present invention creates and sends a letter to the borrower/seller scheduling a viewing of the master art.

At step 25 the review will begin with the artist, is the artist considered a master? From what school or art movement and time period is the artist?

At step 26 the history of ownership will be reviewed by looking at the provenance to see the chain of ownership.

At step 27 the history will be reviewed to see if there are any gaps during the WWII period.

At step 28 the Art Loss Register will be consulted to see if the master art has a claim.

At step 29 the sales indices of auction houses and private data from dealers will be consulted to see the demand for the artist and the prices at which other pieces of the artist sold.

At step 30 the insurance value will be reviewed to see if the piece is valued accordingly and how much the premiums cost.

At step 31 the condition will be reviewed to see what conservation steps have been taken and if any are needed.

At step 32 after examination of the master art and accompanying documentation, a written letter of the advisability to proceed or not proceed will be generated and the system of the present invention creates and sends a letter notifying the borrower/seller at step 3a/b, 4a/b, 5a/b or 6a/b that the master art did or did not pre-qualify for full due diligence and that the application has been denied or approved. As stated before in Steps 3a and 3b, there are several reasons why a piece of master art will or will not pre-qualify.

In the event it is approved, as stated in Steps 6a and 6b, the system of the present invention further creates a letter of intent wherein the lender/purchase shall have the right to conduct a basic credit check and ability to service the debt on the borrower in the event of a loan and the right to conduct extensive research on the authenticity of the master art. Borrower must execute the letter of intent that includes acceptance of the “Terms and Conditions for Due Diligence”, as stated in steps 7a and 7b. The executed letter of intent can be transmitted to the lender in any one of a variety of different methods, including via Fax, e-mail, first-class mail, or via overnight courier as stated in steps 5a and 5b.

The preliminary examination will depend on the viewing and the documentation on each individual master art piece. Steps 25-31 can be changed to give each a higher or lower value. For example, if a work a work has a gap in provenance but the work does not have a claim, then lender may accept a less than perfect provenance at the preliminary examination stage.

FIG. 4 is a flowchart illustrating the steps in master art full due diligence.

At step 33 the system of the present invention opens the module for full due diligence.

In this module the system of the present invention creates a file where the executed letter of intent from step 32 has been scanned and filed. The letter of intent gives the lender, for a period of six (6) weeks, the right to do full due diligence to find out if the master art and the borrower qualify for a loan or if the master art qualifies for a purchase. Lender/buyer will also have unrestricted access to the master art and also the right to remove the master for test and viewings at other locations. However, borrower will still have possession of the master art. Lender/buyer will assign one or more specific expert(s) to handle the full due diligence. In the art industry there are specific experts who are considered authorities in authenticating the master art of specific masters, their periods, schools or movements. There are also museum-trained professionals, artists, and craftspeople that provide a wide range of art handling expertise to museums, galleries, auction houses and private collectors. Lender/buyer will work with these experts. The experts are located anywhere in the world with an Internet connection. The expert uses a system of the present invention to log in and view the application created at step 23, and input information as to his/her tests and findings for each category. At the end of the full examination of the master art, the expert(s) will submit a written report on the advisability to proceed or not proceed.

The foremost purpose any full due diligence authentication activity is to determine first the authenticity and then the value of the particular piece of master art.

In authenticity research, there are only four possible outcomes and these are ranked below from the easiest to the most difficult:

1. THE WORK IS A “FAKE”—this terminology is used quite specifically to define a circumstance where there has been a deliberate attempt to mislead individuals or the public into believing a master art is of a particular era or by the hand of a particular master. Sometimes, these deceptions are not so easy to spot but in general they are recognized soon into the process. The reason for this is that each master used techniques, materials and other variables unique to them. These work as a type of “signature” that is only attributable to such master. When these techniques, materials and other variables are not present then the work cannot be from the master. Most counterfeiters only control a few of these techniques, materials and other variables and are not able to create the particular “signature”.

2. THE WORK IS A “COPY” this refers to works that are deliberate copies of master art. There is little or no need to attribute the work to a particular hand. A good example of this is the western studio practice in painting and sculpture (basically until the 20th century) that included the systematic copying of master art by apprentices. There was originally no intent to deceive or mislead a potential owner or buyer. There may well be subsequent attempts to pass the objects off as genuine.

3. THE WORK IS “AUTHENTIC”—the master art is by a particular artist or from a specific school, movement, or historical period.

4. THE WORK IS “FROM A PARTICULAR SCHOOL, ART MOVEMENT OR PERIOD BUT AN ARTIST WHO IS LESSER KNOWN OR UNKNOWN ARTIST”—this is the most difficult category. In some cases it is not so easy to determine, with high degree of specificity and confidence the exact authorship for master art from the 16^{th} to the 19^{th} century. Historically it has been the norm rather than the exception that up until the 20^{th} century, artists would start off as apprentices to a master who would teach them to paint in his style. Eventually, the artist would break off from the master and create his own style, school or movement, but not all apprentices achieved this status.

In establishing the value as also stated in step 29, the key issue is to set a dollar amount that a willing buyer pays a willing seller under normal circumstances, or would reasonably be expected to pay under normal circumstances or the fair market value. The price that similar works of art sell for at auction is generally accepted to be an accurate estimate of fair market value. At auction, art is generally required to sell immediately, with no fanfare or restrictions, to the highest bidders. However, value has other components that are subjective in nature. These include peoples' tastes, demand, quality, condition, rarity, and recent private sales. All of these factors need to be addressed in establishing value.

At step 34 the system of the present invention opens the sub-module for the section related to credit within full due diligence in case the application is for a loan. The lender will do a basic credit check credit on the borrower.

At step 35 the lender will review in conjunction with the borrower's credit report borrower's ability to service the debt.

However, as a result of the potential value of the master art, the credit worthiness and ability to service the debt is not paramount in determining whether a loan is approved, what is paramount are the results of the full due diligence on the master art.

At step 36 the system of the present invention opens the module for full due diligence. The key issues to consider when weighing a potential loan on art as collateral are the authenticity and the value. Therefore, the process begins with the master and attributing the piece of art as genuine and from that particular master's hand or authenticity. The assigned expert(s) begin by analyzing the specimen's qualities such as the technique, the materials and other variables that are strictly particular to a particular master and whether the work has that master's “signature”. Once authenticity has been established, the process is dynamic and it is determined by the circumstances unique to each piece of master art. The process continues with provenance, quality, rarity, conservation, and finally to value. All of these factors figure in the determination process and are assigned a different weight. Sometimes allowances may be made if a work has been determined authentic and is viewed as the turning point within the context of the artist's oeuvre. In this case, one might have to accept a less than perfect provenance if there is no Art Loss Register claim. Or if a work is extremely rare one might have to accept a less than perfect state of conservation.

At Step 37 lender/buyer begins with classifying the artist, the school, art movement, and the time period.

At Step 38 lender/buyer proceeds to authenticity. Authenticity is the process describing evidence that attributes a piece of master art to a specific master artist as the original. The comprehensive examination process includes, but is not limited to, the following analyses:
Radiological analyses and comparisons
Comparative photoelectric analyses
Physiological analyses of the canvas
Dendrochronological analyses, if required in the case of wooden panels
Chemical analyses of colors
Analyses of past conservations

At step 39 lender/buyer proceeds to provenance. Provenance is a list of the previous owners of a master art, tracing it from its present location and owner back to the hand of the artist. Provenance has many uses: It can help to determine the authenticity of a work, to establish the historical importance of a master's oeuvre by suggesting other artists who might have seen and been influenced by it, and to determine the legitimacy of current ownership.

At step 40 in conjunction with step 39, lender/buyer proceeds to check any gaps in the provenance and any legitimate reason for it. Although provenance research is intended to establish an unbroken chain of documented ownership from the moment of a piece of master art's creation to the present, this goal is sometimes not easily achieved. There are a number of legitimate reasons for gaps in known provenance during any time period. The art historical scholarship for that particular piece simply may not exist. Even if there is a scholarly compilation of a master's body of work, or a “catalogue raisonné”, the particular piece of master art be have not been included, as the master art may have remained hidden in an unknown private collection for decades, never published or exhibited.

At step 41 lender/buyer proceeds to check the Art Loss Register in conjunction with step 40 for even though there may be a legitimate reason for a gap in provenance there may exist a claim to such master art in the Art Loss Register.

At step 42 lender/buyer proceeds to quality. Quality assesses the relative aesthetic merits or the beauty of a given piece of master art, evaluating it both within the larger context of art history and within the specific context of the artist's oeuvre.

At step 43 lender/buyer proceeds to rarity. Although there are exceptions, rarity tends to enhance value. The rarity of a given work is determined by how many similar examples exist and how frequently such works become available for acquisition.

At step 44 lender/buyer proceeds to condition. The condition of a piece of master art is important. Inept restoration can impair value even more than neglect can. It is very important to understand the condition of a piece of master art and to assess its vulnerability to handling and moving, either from room to room, or across countries. With some artists or types of work, it may be impossible to find an example in pristine condition and the condition must be interpreted in the context of the age of the work and the impact of condition on a given work's value.

At step 45 lender proceeds to value. As stated in step 33 value has both objective and subjective factors. Tastes and market conditions change and values change accordingly. For example, the academic art of the nineteenth century, in its day, far outpaced in price the work of the contemporary Impressionists, only to be eclipsed by the latter group as the twentieth century progressed. The evaluation of a specific work depends on such numerous factors including peoples' tastes, demand, quality, condition and recent sales, both public and private.

At step 46 a conclusion will be reported. The final report will include:
1) All technical findings including those that reflective negatively on authenticity; and
2) A determination of authenticity and value.

The system of the present invention creates and sends a letter notifying the borrower at step 9a/b, 10a/b, 11a/b or 12a/b that the master art did or did not qualify for a loan/purchase and that the application has been denied or approved. If denied the process ends for both transaction types. If approved, the system of the present invention also creates a promissory note and security agreement or a purchase agreement.

FIG. 5a is a flowchart illustrating the steps undertaken to process a master art promissory note and security agreement.

At step 47a the system of the present invention opens the module for the promissory note from step 17a. This is where the lender agrees to lend money to borrower and where borrower agrees to pay the loan back at some future time. It is an unsecured interest and represents borrower's in personam indebtedness.

At step 48a the system of the present invention opens the module for the security agreement. This is where attachment of the described master art collateral occurs giving lender a security interest in the master art against the collateral for the loan and represents the property's in rem indebtedness. The promissory note and the security agreement are sent to the borrower with their terms as a loan offer for execution. If the borrower declines the offer, the process ends for a loan as described in steps 14a and 15a. If the borrower accepts the offer, the borrower executes the promissory note and the security agreement and sends it back to lender as described in steps 16a and 17a.

At step 49a the lender perfects its security interest by taking possession. This where perfection occurs giving lender priority over other classes of borrower's creditors in the exercise of the security interest in case of debtor's bankruptcy and identification of creditors' priority to assets.

At step 50a, lender issues a letter of credit to the borrower in the amount of the loan.

At step 51a simultaneously with step 50, lender concludes a storage agreement in its name.

At step 52a the collateral master art is entered into inventory and its exact storage location is recorded on the file. The system of the present invention creates a new file and all the documents are filed together and lender programs for a reminder to be given notifying lender that the loan payoff term will be over in sixty (60) days. The lender stores the collateral master art until the borrower either repays the loan amount or defaults on the loan.

At Step 53a the system of the present invention creates a private online account page on lender's website from step 22a where borrower can see the status of his/her account.

FIG. 5b is a flowchart illustrating the steps undertaken to process a master art purchase agreement.

At step 47b the system of the present invention opens the module for a purchase with the purchase agreement from step 17b.

At step 48b the parties can agree to a full payment of the purchase price or two payments. For a number of economic, business and tax reasons, a seller may wish to receive the purchase price deferred in two (2) payments. In order to do so the seller must check the appropriate box in the form agreement. The parties agree that even though payment is structured in two (2) payments, the seller will take possession of the master art and seller will issue two (2) letters of credit. The time span between the first and second payment as verified by the letters of credit cannot be longer than ninety (90) days. The purchase agreement is sent to the seller with its terms as a purchase offer for execution. If the seller declines the offer, the process ends for a purchase as described in steps 14b and 15b. If the seller accepts the offer, the seller executes the purchase agreement and sends it back to buyer as described in steps 16b and 17b.

At step 49b the lender takes possession.

At step 50b in conjunction with step 49b, seller issues a letter of credit to the borrower in the amount of the purchase payment. If the seller has chosen two (2) payments, buyer will issue two (2) letters of credit. The first letter of credit is payable on the date buyer takes possession. The second letter of credit is payable on the date agreed to by the parties up to ninety (90) days from the date of the first letter of credit.

At step 51b simultaneously with step 50b, buyer concludes a storage agreement in its name.

At step 52b the collateral master art is entered into inventory as purchased master art pursuant to the payment schedule and its exact storage location is recorded on the file. The system of the present invention creates a new file and all the documents are filed together.

At Step 53b the system of the present invention creates a private online account page on buyer's website from step 22b where seller can see the status of his/her account in the event it has chosen a two (2) payment structure.

FIG. 6 is a flowchart illustrating the steps undertaken to process a master art loan pay off.

At Step 54 the system of the inventory module of the present invention sends a reminder from step 52a to lender that the loan payoff term will be over in sixty-five (65) days and prepares a loan pay-off notice to be sent to borrower. Lender sends borrower a loan pay-off notice sixty (60) days prior to the expiration of the promissory note and security agreement with all due amounts, the date due and instructions of how to make payment. The same notice also indicates that if the due amounts are not paid on the date due the borrower will be in default. The due date, notice date and the manner of payment have been mutually agreed upon on the promissory note and security agreement and are restated as part of the instructions sent to borrower with the loan pay-off notice. Maturation of the loan occurs no longer than eighteen months after date of execution of the promissory note and security agreement.

At Step 55 the borrower must pay the loan balance with a letter of credit, which is payable on the date the borrower receives the master art collateral back from lender.

At Step 56 if the lender receives the letter of credit as agreed, the master art is returned to the borrower. In general terms, the date, the manner, and the location to which the master art will be returned has been mutually agreed upon on the promissory note and security agreement and are coordinated in specific at the time of the transaction in conjunction with Step 55.

At Step 57 once the master art has been returned, the inventory is updated and the particular master art is deleted from inventory.

FIG. 7 is a flowchart illustrating the steps undertaken to process a master art loan default.

At Step 58 the lender and the borrower have agreed in the promissory note and security agreement that non-payment is an event constituting default.

At Step 59 the lender makes an entry into the inventory database noting the default.

At Step 60 when borrower is in default under the promissory note and security agreement, the lender has the option to (1) sell the property covered by the security interest via a public or private sale; or (2) retain the master art covered by the promissory note and security agreement via strict foreclosure procedures if the borrower agrees. Depending on the option lender has chosen and proceeded with, the master art will be classified as sold or as property of the lender.

FIG. 8 is a flowchart illustrating the operation of inventory management of the master art.

At Step 61 an embodiment of the present invention opens up the inventory management module.

At Step 62, 63, 64, 65, 66 lender/buyer enters into inventory new pieces of master art and classifies them as collateral security, purchased, returned or master art in default.

At Step 67 lender/buyer reconciles the inventory database. As discussed above, lender will collateralize and take possession of master art in exchange for monetary funds. Similarly, buyer will purchase master art. As a result lender/buyer will have a large collection of master art that must be properly tracked and managed with a method and system to track such. As discussed, in Steps 21a/b, 52a/b, 54,57, and 59 each piece of master art is properly entered, categorized and tracked as to it status within the loan and/or purchase process. The master art is also identified as to its storage facility. The inventory database maintains a record of each item of master art including artist name, title of the piece, title of the school, title of the art movement, year, value, location where stored, and time left on the loan or if a second payment is scheduled on a purchase. Linked to the identification data are the borrower/seller's information for each item, such as name and contact information. Lender/buyer may use any number of a variety of methods to track the master art information. Lender/buyer will run an inventory report every thirty (30) day period.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. A due diligence and finance method having the steps of:
(a) identifying at least one piece of art as master art;
(b) pre-qualifying said master art for full due diligence;
(c) executing said full due diligence;
(d) establishing authenticity of said master art;
(e) establishing a value of said master art, said value applied as collateral to:
(i) facilitate lending of money; or
(ii) facilitate quick private sale of said master art, said lending of money or proceeds from said sale being provided to an applicant.

2. The due diligence and finance method and system of claim 1 further comprising:
(a) receiving an application, electronic or written, from an applicant desiring one of (i) a loan giving only master art as collateral; or a sale of a piece of master art via an electronic communications network;
(b) compiling information identifying an applicant and information about said master art;
(c) pre-qualifying said master art for full due diligence;
(d) executing full due diligence;
(e) approving a loan or approving a purchase;
(f) paying loan or purchase proceeds to said applicant; and
(h) acquiring possession of said master art.

3. The method of claim 1 wherein upon approval of pre-qualification, a lender/buyer sends a notification with a letter of intent notifying said applicant that the master art pre-qualified for further full due diligence.

4. The method of claim 1 wherein said full due diligence comprises: a basic credit check if said system is used for a loan application and full due diligence on the master art includes information on artist, authenticity, provenance, quality, rarity, conservation, and value of said master art.

5. The method of claim 1 wherein a promissory note and security agreement/purchase agreement are executed by said applicant.

6. The method of claim 1 wherein a loan is made to said applicant whereby said master artis a single exclusive source of collateral for said loan.

7. A system for due diligence of master art to determine authenticity and value for lending money on said master art as a single exclusive source of collateral, said system comprising:
(a) providing a computer readable medium with a system for due diligence of master art, said system configured to collect information relating to authenticity and value for lending money on master art as a single exclusive source of collateral;
(b) a computer for reading said computer readable medium that operatively communicates with a computer network;
(c) one or more steps of: receiving an electronic application from an applicant via lender's website, including information identifying an applicant and information about said master art; pre-qualifying said master art for due diligence; executing full due diligence; approving a loan; paying loan proceeds to said applicant; taking possession of master art.

8. The system of claim 7 further comprising:
approving alternatively, a purchase in place of said loan;
paying purchase proceeds to said applicant; taking possession of said master art.
